(19) United States
(12) Patent Application Publication
(10) Pub. No.: US 2004/0111496 A1
(43) Pub. Date: Jun. 10, 2004

(54) Home network system and method for adding and/or deleting home appliances

(75) Inventors: Sun Mi Han, Seoul (KR); Sang Kyun Lee, Kyungki-do (KR); Yeon Kyoung Lee, Kyungki-do (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/461,681

(22) Filed: Jun. 16, 2003

(30) Foreign Application Priority Data
Dec. 10, 2002 (KR) 2002-78323

(51) Int. Cl. G06F 15/177

(52) U.S. Cl. 709/220; 709/250

(57) ABSTRACT

A home network system and a method for adding and/or deleting home appliances thereto/therefrom. The home network system is constructed so that a plurality of home appliances can transmit and receive data to/from one another. The home appliances are assigned logical addresses, respectively. A plurality of power line modems are connected respectively to the home appliances to modulate and demodulate data transmitted and received over an internal network by the home appliances. A network master is provided to assign the logical addresses to the home appliances and a home address to each of the power line modems, respectively. Therefore, the home network system can be efficiently constructed, and a desired home appliance can be simply deleted from the internal network.

### CROSS-REFERENCE TO RELATED APPLICATION

The present application claims priority under 35 U.S.C. § 119 of Korean Application No. 10-2002-0078323, which was filed on Dec. 10, 2002, the entire disclosure of which is expressly incorporated by reference herein in its entirety.

### BACKGROUND OF THE INVENTION

1. Field of the Invention

The present invention relates to home network systems and methods for adding/deleting home appliances thereto/therefrom. More particularly, the present invention relates to a home network system and a method for adding/deleting home appliances thereto/therefrom, wherein data is transmitted and received over a power line communication network and logical addresses are efficiently assigned/deleted to/from a plurality of home appliances.

2. Description of the Related Art

Generally, a home network system is connected to an internal network constructed in a home so that a plurality of home appliances in the home can transmit and receive data to/from one another over the internal network. The home appliances are controllable according to the data received over the internal network. The home appliances, after being controlled according to the data received over the internal network, output information regarding their controlled states externally so that they can be externally monitored.

FIG. 1 is a schematic view of a conventional home network system constructed as described above.

As shown in FIG. 1, the conventional home network system comprises an internal network I which is constructed in a home and provided with an Ethernet network or power line communication network, and a plurality of home appliances H1-Hn which are connected to the internal network I. Each of the home appliances H1-Hn is generally configured to include a modem (not shown) for performing transmission and reception of data with the internal network I. As a result, the home appliances H1-Hn can each transmit and receive data to/from the internal network I through the modem therein. The home appliances H1-Hn each can also transmit and receive data through the modem therein to/from a personal computer (PC), etc. on an external network O which is connected with the internal network I via the Ethernet network. In this regard, the home appliances H1-Hn are also controllable by means of the PC, etc. on the external network O.

However, the above-mentioned conventional home network system has a disadvantage in that it is not possible to distinguish among a plurality of home appliances connected to an internal network constructed in a building having a plurality of offices or homes, rather than an internal network independently constructed in one home as stated above. For example, air conditioners installed respectively in first and second offices, both of which communicate using a power line, are not assigned separate identifiers, such as home addresses, thereby making it impossible to externally make a distinction therebetween and thus to independently control them.

### SUMMARY OF THE INVENTION

Therefore, the present invention has been made in view of the above-described problem. It is an object of the present invention to provide a home network system and a method for adding/deleting home appliances thereto/therefrom, wherein a plurality of home appliances are installed in a building. These home appliances transmit and receive data over one internal network and are readily controllable in the building on a group basis.

In accordance with one aspect of the present invention, the above and other objects can be accomplished by the provision of a home network system having a plurality of home appliances for transmitting and receiving data over a power line communication network constructed in a home or building. The home appliances are controllable according to the data received over the power line communication network. The invention can further include a plurality of power line modems connected respectively to the home appliances for modulating and demodulating data so that the home appliances can perform power line communications. Finally, the invention may include a network master for assigning a home address to each of the power line modems and logical addresses to the home appliances, respectively, and managing the data transmission and reception over the power line communication network.

In accordance with another aspect of the present invention, there is provided a method for deleting at least one home appliance from a home network system. The method allows a network master to transmit a home address deletion command to a power line modem connected with the home appliance to be deleted, over a power line communication network constructed for the home network system. The network master manager transmission and reception of data over the power line communication network. The method further allows the power line modem to transmit a logical address deletion command to the home appliance in response to the home address deletion command. The method also allows the home appliance to delete a logical address in response to the logical address deletion command. Finally, the method allows the power line modem to delete a home address after the home appliance deletes the logical address.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically showing the construction of a conventional home network system;

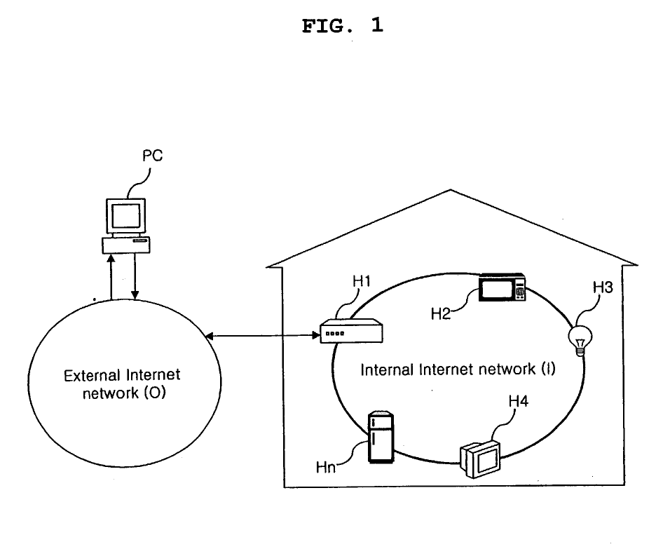

FIG. 2 is a view schematically showing the construction of a home network system in accordance with the present invention;

FIG. 3 is a block diagram of a home appliance and power line modem for the home network system of FIG. 2;

FIG. 4 is a view illustrating the flow of data transmitted and received when a network is initially constructed in the home network system of FIG. 2;

FIG. 5 is a view illustrating the flow of data transmitted and received when a home address is assigned to a power line modem connected to the network of FIG. 2;

FIG. 6 is a view illustrating the flow of data transmitted and received when a logical address is assigned to a home appliance connected to the network of FIG. 2;

FIG. 7 is a view illustrating the flow of data transmitted and received when a home appliance is deleted from the network in FIG. 2; and

FIG. 8 is a view illustrating the flow of data transmitted and received when a home address of a power line modem connected to the network in FIG. 2 is changed.

### DESCRIPTION OF THE PREFERRED EMBODIMENTS

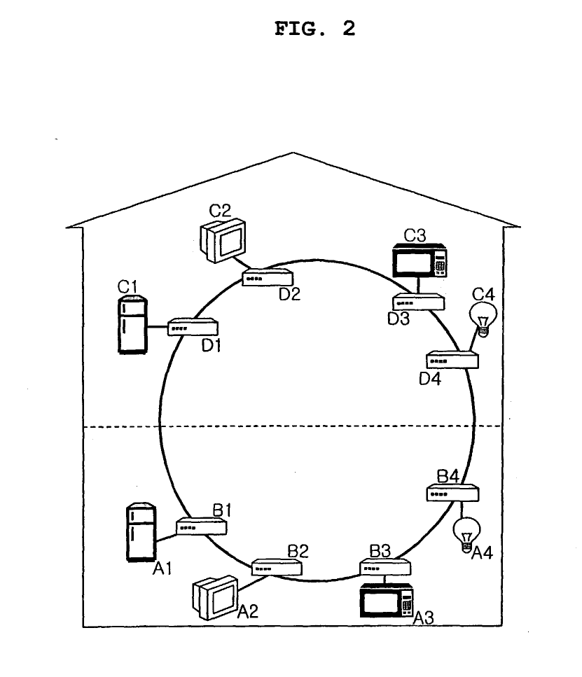

The construction of a home network system in accordance with the present invention, is shown in FIG. 2. As shown in this drawing, the home network system comprises an internal network I constructed in a building having a plurality of offices or homes (e.g., apartments). It should be noted that such a network can be constructed in any suitable structure, such as, schools, hospitals, and airports having multiple sections or divisions. Appliances in the building can transmit and receive data to/from one another over the internal network I. The internal network I may e.g., be an Ethernet network, power line communication network, wireless network (including wi-fi or bluetooth technology as non-limiting examples only). However, it will be described in the present embodiment to be the power line communication network. Any known communication medium and associated communication protocol are expressly within the spirit and scope of the invention.

The home network system further includes a plurality of home appliances A1-A4 of a first home (lower half of structure shown in FIG. 2) for transmitting and receiving data over the internal network I. The appliances can include any known type of home or office appliances, such as televisions, microwaves, refrigerators, personal computers, copiers, lighting systems, ovens, stoves, security systems, VCRs and other home entertainment devices, as non-limiting examples only.

A plurality of power line modems B1-B4 are connected, respectively, to the home appliances A1-A4 for modulating and demodulating the data transmitted and received over the internal network I by the home appliances A1-A4. A plurality of home appliances C1-C4 of a second home (upper half of structure shown in FIG. 2) for transmitting and receiving data over the internal network I, and a plurality of power line modems D1-D4 are connected respectively to the home appliances C1-C4 for modulating and demodulating the data transmitted and received over the internal network I by the home appliances C1-C4.

Preferably, a specific appliance, for example, A1 of the home appliances A1-A4 in the first home functions as a network master for managing the transmission and reception of data over the internal network I in the first home. This master appliance has a capability of displaying a home appliance list containing information about all the home appliances A1-A4 and of transmitting and receiving data over the internal network I in the first home. Also, a specific appliance, for example, C1 of the home appliances C1-C4 in the second home functions as a network master for managing the transmission and reception of data over the internal network I in the second home. This appliance C1 has a capability of displaying a home appliance list containing information about all the home appliances C1-C4 and of transmitting and receiving data over the internal network I in the second home.

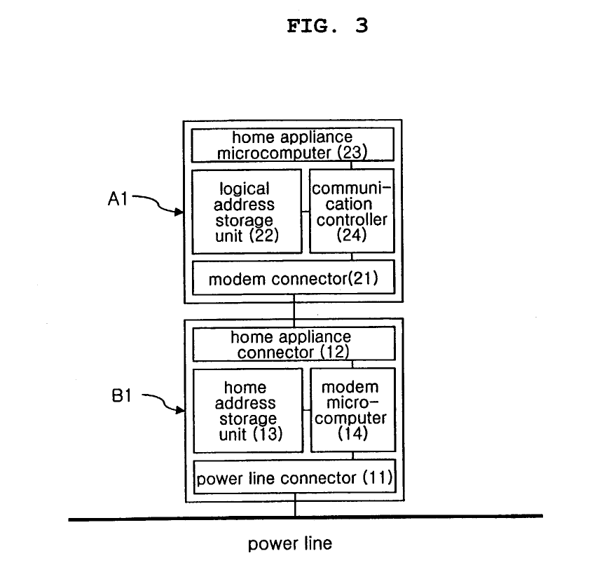

Furthermore, the power line modems B1-B4 and D1-D4 and the home appliances A1-A4 and C1-C4 are interconnected to a power line as shown in FIG. 3. The home appliances A1-A4 and C1-C4 can thus transmit and receive data to/from one another over the power line communication network.

More specifically, the power line modem, for example, B1 includes a power line connector 11 for transmitting and receiving data over the power line communication network constructed for a home network in the home or building. Furthermore, the power line modem has a home appliance connector 12 for transmitting and receiving data to/from the home appliance, for example, A1 that is connected with the power line modem B1. The modem further includes a home address storage unit 13 for storing a home address assigned by the network master connected with the power line communication network, and a modem microcomputer 14 for controlling the data transmission and reception of the power line connector 11 and home appliance connector 12 and transmitting data corresponding to the home address stored in the home address storage unit 13. The modem B1 transfers data received through the power line connector 11, to the home appliance A1 connected with the power line modem B1.

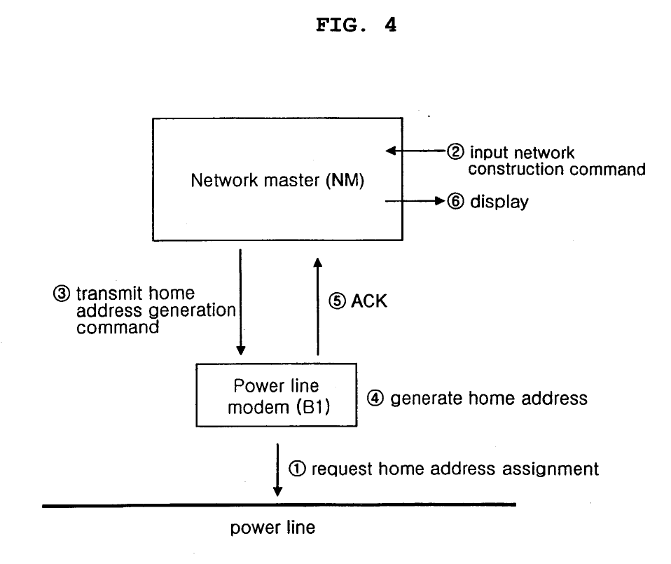

With respect to home addresses, the modem microcomputer 14 and the power line modem B1 will transmit a home address assignment request signal to the network master when the modem B1 has no home address assigned thereto. Thereafter, the microcomputer 14 can receive a home address assigned by the network master and store the received home address in the home address storage unit 13, as will be described later in detail with reference to FIGS. 4, 5, 6, 7 and 8.

The home appliance A1 includes a modem connector 21 for transmitting and receiving data to and from the power line modem B1 that is associated with the home appliance A1. The home appliance A1 further includes a logical address storage unit 22 for storing a logical address received through the modem connector 21, a home appliance microcomputer 23 for controlling the home appliance A1, and a communication controller 24 for controlling the data transmission and reception of the modem connector 21 and transferring a control command received through the modem connector 21 to the home appliance microcomputer 23.

It should be noted that each (or some) of the components of appliance A1 and the modem B1 can be combined. That is, the appliance A1 and modem B1 do not necessarily have to contain each of the above-noted separate parts but the functional components can be combined into a single device. The above description is understood to be a non-limiting example only.

Besides functioning to transfer the control command received through the power line modem B1 to the home appliance microcomputer 23, the communication controller 24 also functions to check the logical address storage unit 22 to determine whether the home appliance A1 has a logical address assigned thereto. The communication controller 24 can transmit a logical address assignment request signal to the network master through the power line modem B1 if the home appliance A1 has no logical address assigned thereto, as will hereinafter be described in detail with reference to FIGS. 4, 5, 6, 7 and 8.

As shown in FIGS. 4, 5, 6, 7 and 8, packets are transmitted and received when the home network system according to the present invention, is applied to only the first home. For the convenience of description, the first home appliance A1 of the first home will hereinafter be referred to as a network master NM. The second home appliance A2, which is controlled by the network master NM is a general home appliance with no network management function. It will hereinafter be referred to as a slave S.

A home network system is initially created, as shown in FIG. 4, when the power line modem B1, which is connected with a Plug-and-Play (PnP) support network master NM having a user display with a Graphical User Interface (GUI), is connected to the power line communication network. In the initial operation, the power line modem B1 performs normal communications if it has a home address assigned thereto. However, when the power line modem B1 has no home address assigned thereto, it transmits a home address assignment request signal or command (for example, a data packet) to the power line communication network (\mathring{1}). It should be noted here that the “home address” is assigned on a per home basis and all home appliances installed in one home have the same home address. Just like the power line modem B1, when power line modems connected with home appliances operating as slaves devices S, other than the network master NM, are connected to the power line communication network, they all initially determine whether they have home addresses assigned thereto. The power line modems will transmit home address command assignment requests (for example, in the form of data packets) to the power line communication network, if they have no home addresses assigned thereto.

On the other hand, a home appliance user in the home inputs a network construction or create command to the network master NM (\mathring{2}). The network master NM transmits a home address generation command to the power line modem B1 (\mathring{3}) (in response to the network construction command input by the user (\mathring{2}). Upon receiving the home address generation command from the network master NM, the power line modem B1 generates a home address (\mathring{4}) and transmits an acknowledge (ACK) signal to the network master NM (\mathring{5}). In response to the ACK signal from the power line modem B1, the network master NM displays a signal indicative of the fact that the initial network construction has been successful (\mathring{6}), so that the user can recognize such a fact.

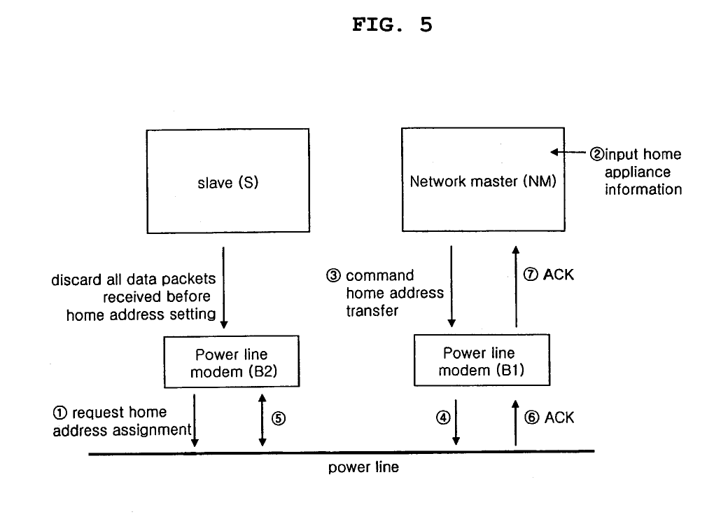

Next, an aspect of the invention where a new appliance is added will be discussed. In the case where a new home appliance operating as a slave device S is added to the home network system, constructed as stated above, signals or commands (for example, data packets) are transmitted and received as shown in FIG. 5.

A new slave device and associated modem will initiate operation in the same manner as the power line modem B1 connected with the network master NM described above. In its initial operation, a power line modem, for example, B2 connected with the new home appliance operating as the slave device S determines whether it has a home address assigned thereto, and transmits a home address assignment request signal to the power line communication network if it has no home address assigned thereto (\mathring{1}).

On the other hand, the user adding the new home appliance to the home network system can alternatively input, to the network master NM, information regarding a place where the new home appliance is installed, along with information regarding the fact that the new home appliance has been added (\mathring{2}). Then, the network master NM commands the power line modem B1 connected therewith to transfer a home address to the power line modem B2 requesting the home address assignment (\mathring{3}).

Thereafter, the power line modem B1 connected with the network master NM transmits a home address setting signal to the power line modem B2 connected with the slave device S (\mathring{4}), and the power line modem B2 transmits an ACK signal to the power line modem B1 in response to the home address setting signal therefrom (\mathring{4}).

Upon receiving the ACK signal from the power line modem B2 (\mathring{6}), the power line modem B1 connected with the network master NM transmits an ACK signal indicative of the ACK signal reception to the network master NM (\mathring{7}). Notably, the new slave device S added to the home network system will discard all data packets or other communications received before a home address is set in the power line modem B2 connected therewith. Also, if the power line modem B1 receives no ACK signal from the power line modem B2 within a predetermined time, such as, for example, 4 seconds from the transmission of the home address setting signal thereto, it re-transmits the home address setting signal thereto.

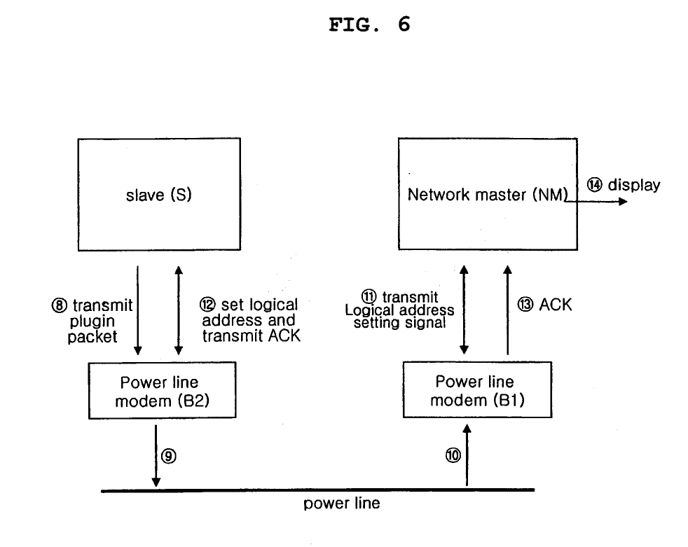

Next, another aspect of the invention will be discussed with reference to FIG. 6. FIG. 6 illustrates the flow of data transmitted and received when a logical address is assigned to the slave device S after a home address is assigned to the power line modem B2 connected with the slave device S as stated above. It should be noted here that the “logical address” is used to make a distinction among a plurality of home appliances using the same home address when data is transmitted and received among the home appliances, and the home appliances are assigned different logical addresses, respectively.

First, the added new slave device S transmits a plugin packet (as an example, but any form of communication would be within the spirit and scope of the invention) to the power line modem B2 after recognizing that it has no logical address assigned thereto (\mathring{8}). The power line modem B2 connected with the slave device S, transmits the plugin packet from the slave S to the power line modem B1 connected with the network master NM (\mathring{9}). Upon receiving the plugin packet transmitted from the power line modem B2 (\mathring{10}), the power line modem B1 notifies the network master NM of the plugin packet reception, and the network master NM then transmits a logical address setting signal containing a logical address to the power line modem B1 (\mathring{11}).

The logical address setting signal from the network master NM is transmitted through the power line modems B1 and B2 to the slave device S, which then sets the logical address contained in the transmitted setting signal therein and transmits an acknowledgement ACK signal (\mathring{12}). The ACK signal from the slave device S is transmitted to the network master NM via the power line modems B2 and B1 (\mathring{13}). As a result, the network master NM externally displays information indicative of the fact that the new home appliance has been successfully registered (\mathring{14}).

Notably, the power line modem B2 connected with the added new slave device S discards all packets transferred from the slave device S before a home address is set, and performs the step of receiving a logical address only after the home address is set as shown in FIG. 5.

If that the network master NM receives no ACK signal from the slave S after transmitting the logical address setting signal thereto, it transmits a search packet or command to the power line communication network so as to search for information regarding the added new home appliance and subsequently updates its database with the searched information.

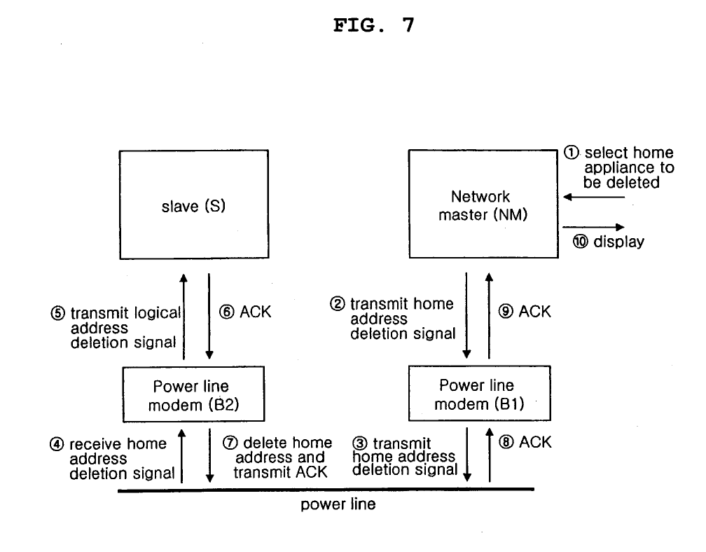

FIG. 7 illustrates the flow of data transmitted and received when a home appliance is deleted from the home network system constructed or created as stated above.

First, the user selects a home appliance to be deleted from a home appliance list displayed on the network master NM (\mathring{1}). The network master NM transmits a home address deletion signal to the power line modem B1 connected therewith to in turn transmit it to a power line modem, for example, B2 connected with the selected home appliance, or slave device S. The power line modem B1 connected with the network master NM transmits the home address deletion signal to the power line modem B2 connected with the slave device S (\mathring{3}). Upon receiving the home address deletion signal from the power line modem B1 (\mathring{4}), the power line modem B2 transmits a logical address deletion signal to the slave device S connected therewith (\mathring{5}).

Thereafter, if the power line modem B2 connected with the slave device S receives an ACK signal from the slave device S (\mathring{6}), it deletes a home address assigned thereto and transmits an ACK signal indicative of the address deletion to the power line modem B1 connected with the network master NM (\mathring{7}).

Upon receiving the ACK signal from the power line modem B2 (\mathring{8}), the power line modem B1 for the network master NM transmits the received ACK signal to the network master NM (\mathring{9}). Thereafter, the network master NM externally displays information indicative of the fact that the selected home appliance has been successfully deleted (\mathring{10}). Notably, the power line modem B2 discards all data packets received over the power line communication network from a point of time that it receives the home address deletion signal to a point of time that the home address deletion is completed.

Further, if the network master NM receives no ACK signal from the power line modem B1 within a predetermined time, such as e.g., 5 seconds from the transmission of the home address deletion signal, it re-transmits the home address deletion signal. Where the network master NM also receives no ACK signal within e.g., 5 seconds from the re-transmission of the home address deletion signal, it transmits a PING message (test signal) to the home appliance to be deleted. If there is no response to the PING message, the network master NM determines the home appliance to have been deleted and externally displays the information indicative of the fact that the home appliance has been successfully deleted.

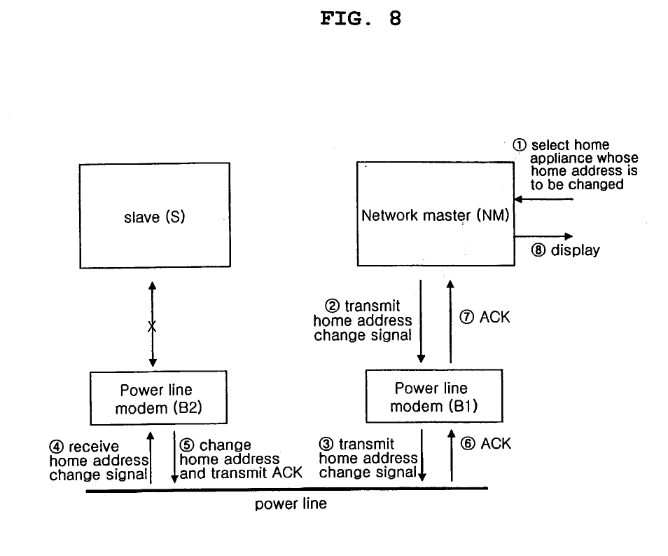

FIG. 8 illustrates the flow of data packets transmitted and received when a home address is manually changed in the home network system constructed or created as stated above.

First, the user selects a home appliance whose home address is to be changed from a home appliance list displayed on the network master NM (\mathring{1}). The network master NM transmits a home address change signal to the power line modem B1 connected therewith to in turn transmit it to a power line modem, for example, B2 connected with the selected home appliance, or slave device S.

Next, the power line modem B1 for the network master NM transmits the home address change signal to the power line modem B2 for the slave device S (\mathring{3}). Upon receiving the home address change signal from the power line modem B1 (\mathring{4}), the power line modem B2 for the slave device S changes the existing home address to a home address contained in the received home address change signal and transmits an ACK signal (\mathring{5}).

Thereafter, the power line modem B1 for the network master NM receives the ACK signal transmitted from the power line modem B2 (\mathring{6}) and transmits it to the network master NM (\mathring{7}). As a result, the network master NM externally displays a signal indicative of the fact that the home address change has been successfully made (\mathring{8}). Notably, in the home address change procedure, there is no change in a logical address assigned to the slave device S.

As is apparent from the above description, the present invention provides a home network system and a method for adding and/or deleting home appliances. The home network system is constructed or created so that a plurality of home appliances can transmit and receive data to and from one another. The home appliances are assigned logical addresses, respectively. A plurality of power line modems are connected respectively to the home appliances to modulate and demodulate data transmitted and received over an internal network by the home appliances. A network master is provided to assign the logical addresses to the home appliances and a home address to each of the power line modems, respectively. Therefore, the home network system can be efficiently constructed, and a desired home appliance can be simply deleted from the internal network.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A home network system comprising:
a plurality of home appliances that one of transmit and receive data over a power line communication network in a structure, said home appliances being controllable according to the data received over the power line communication network;
a plurality of power line modems connected respectively to said home appliances that modulate and demodulate data so that said home appliances can perform power line communications; and
a network master that assigns a home address to each of said power line modems and logical addresses to said home appliances, respectively, and that manages the data transmission and reception over the power line communication network.

2. The home network system as set forth in claim 1, wherein each of said power line modems is configured to determine whether there is a home address assigned thereto when it is newly connected to said power line communication network, and said power line modem is configured to transmit a home address assignment request signal to the power line communication network when there is no home address assigned thereto.

3. The home network system as set forth in claim 1, wherein said power line modems each include:
a power line connector that transmits and receives data over the power line communication network;
a home appliance connector that transmits and receives data to and from one of said home appliances connected with a corresponding one of said power line modems;
a home address storage that stores said home address assigned from said network master; and
a modem microcomputer that controls the data transmission and reception of said power line connector and home appliance connector and transmits data to said home appliance connected with the corresponding power line modem that corresponds to said home address stored in said home address storage among the data received through said power line connector.

4. The home network system as set forth in claim 1, wherein each of said home appliances is configured to transmit a logical address assignment request signal to the power line communication network through the corresponding power line modem after said home address is assigned to said corresponding power line modem when said home appliance is newly connected to a corresponding one of said power line modems..

5. The home network system as set forth in claim 1, wherein said home appliances each include:
a modem connector that transmits and receives data to and from one of said power line modems connected with a corresponding one of said home appliances;
a logical address storage that stores a logical address received through said modem connector;
a home appliance microcomputer that controls the corresponding home appliance; and
a communication controller that controls the data transmission and reception of said modem connector and that transfers a control command received through said modem connector to said home appliance microcomputer.

6. The home network system as set forth in claim 1, wherein said network master is adapted to display a list of said power line modems assigned said home addresses over the power line communication network and a list of said home appliances assigned said logical addresses.

7. The home network system as set forth in claim 6, wherein said network master is adapted to transmit a home address deletion command to one of said power line modems connected with the specific home appliance when a command to delete a specific one of said home appliances contained in said displayed home appliance list is received.

8. The home network system as set forth in claim 7, wherein said power line modem connected with said specific home appliance is configured to transmit a logical address deletion command to said specific home appliance in response to said home address deletion command transmitted from said network master.

9. A method of operating a home network system, comprising:
a) transmitting, by a network master, a home address deletion command to a power line modem connected with a home appliance to be deleted, the deletion command being transmitted over a power line communication network of the home network system, the network master managing transmission and reception of data over the power line communication network;
b) the power line modem transmitting a logical address deletion command to the home appliance in response to the home address deletion command;
c) deleting the home appliance logical address in response to the logical address deletion command and d) the power line modem deleting a home address after the home appliance deletes said logical address.

10. The method as set forth in claim 9, further comprising:
e) the power line modem discarding all data received over the power line communication network after reception of the home address deletion command until deletion of said logical address.

11. A method for operating a home network system, comprising:
a) determining whether a power line modem has a home address assigned thereto when newly connected to a power line communication network of the home network system, the power line modem being connected with the home appliance so that the home appliance can transmit and receive data over said power line communication network;
b) the power line modem transmitting a home address assignment request signal to a network master when it is determined to have no home address assigned thereto, the network master managing the data transmission and reception over the power line communication network; and
c) assigning, by the network master, a home address to the power line modem in response to the home address assignment request signal.

12. The method as set forth in claim 11, further comprising:
d) connecting the home appliance with the power line modem to transmit a logical address assignment request signal to the network master through the power line modem;
e) assigning, with the network master, a logical address to the home appliance in response to the logical address assignment request signal transmitted; and
f) the home appliance storing the logical address.

13. The method as set forth in claim 12, further comprising:
g) the home appliance connected with the power line modem discarding all data received until the home address is assigned to the power line modem.
